(19) United States
(12) Patent Application Publication
(10) Pub. No.: US 2020/0380886 A1
(43) Pub. Date: Dec. 3, 2020

(54) FOOTWEAR INSERT

(71) Applicant: David Erickson, San Antonio, TX (US)

(72) Inventor: David Erickson, San Antonio, TX (US)

(21) Appl. No.: 16/429,740

(22) Filed: Jun. 3, 2019

(51) Int. Cl. G09B 19/00; A43B 11/00

(52) U.S. Cl. CPC G09B 19/0076; A43B 11/00

(57) ABSTRACT

A footwear insert, including a plurality of bodies to be disposed on or within at least a portion of a left shoe and at least a portion of a right shoe, and a plurality of indicators disposed on or within at least a portion of the plurality of bodies to indicate a correct position of the plurality of bodies with respect to each other.

### BACKGROUND

### 1. Field

The present general inventive concept relates generally to an insert, and particularly, to a footwear insert.

### 2. Description of the Related Art

Traditional shoe insoles are plain, offering nothing more than foot support for a consumer. Young children are usually unaware of proper placement of shoes on their feet. As such, inserting a foot corresponding to each shoe can be a problem for children who do not understand the proper placement.

Therefore, there is a need for a footwear insert that instructs children on proper placement of each shoe.

### SUMMARY

The present general inventive concept provides a footwear insert.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a footwear insert, including a plurality of bodies to be disposed on or within at least a portion of a left shoe and at least a portion of a right shoe, and a plurality of indicators disposed on or within at least a portion of the plurality of bodies to indicate a correct position of the plurality of bodies with respect to each other.

Each of the plurality of indicators is at least one of a picture, an image, a letter, a word, and a sound.

The footwear insert may further include a plurality of sensors disposed on or within at least a portion of the plurality of bodies to detect at least one foot being at least partially inserted within the left shoe or the right shoe.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top view of a footwear insert, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Footwear Insert 100
Bodies 110
Left Body 111
Right Body 112
Shoe Indicators 120
Left Shoe Indicator 121
Right Shoe Indicator 122
Sensors 130
Power Sources 140

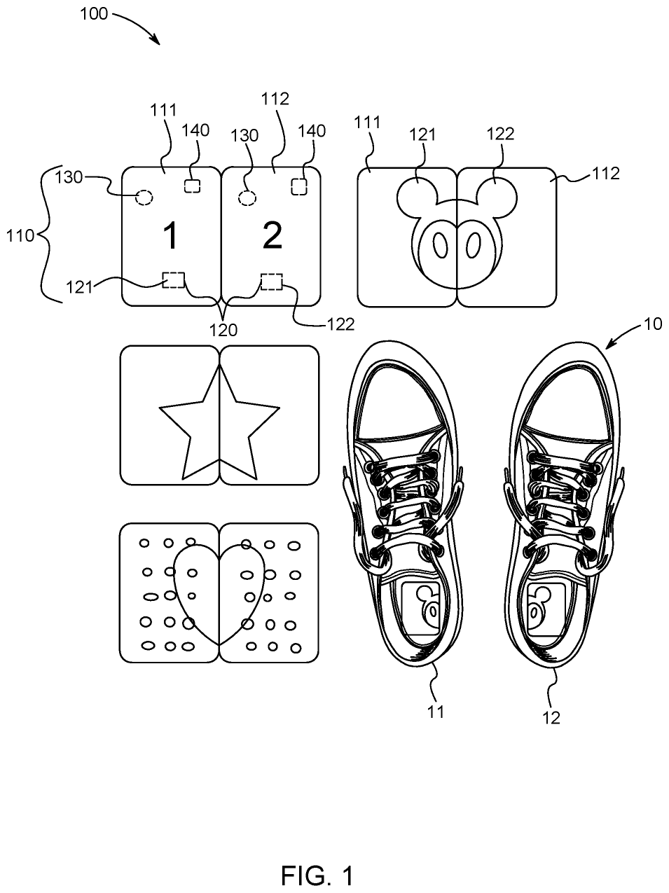

FIG. 1 illustrates a top view of a footwear insert 100, according to an exemplary embodiment of the present general inventive concept.

The footwear insert 100 may be constructed from at least one of metal, plastic, wood, and rubber, etc., but is not limited thereto. The footwear 100 may be highly durable, water resistant, and/or resistant to wear.

The footwear insert 100 may include a plurality of bodies 110, a plurality of shoe indicators 120, a plurality of sensors 130, and a plurality of power sources 140, but is not limited thereto.

Referring to FIG. 1, each of the plurality of bodies 110 are illustrated to be rectangular. However, each of the plurality of bodies 110 may be a same size and/or a same shape as a sole in a pair of shoes 10, etc., but is not limited thereto.

The plurality of bodies 110 may include a left body 111 and a right body 112, but is not limited thereto.

The left body 111 and the right body 112 may be substantial planar. The left body 111 and the right body 112 may be substantially smooth on at least a portion of a top surface and/or at least a portion of a bottom surface thereof. Alternatively, the left body 111 and the right body 112 may be textured, such that the top surface of the left body 111 and/or the top surface of the right body 112 may include a plurality of bubbled protrusions disposed on at least a portion thereof, such that the plurality of bubbled protrusions extending away from the top surface of the left body 111 and/or the top surface of the right body 112.

The plurality of shoe indicators 120 may include a left shoe indicator 121 and a right shoe indicator 122, but is not limited thereto.

The plurality of shoe indicators 120 may be at least one of a picture, an image, a letter, a word, and a sound. In other words, the plurality of shoe indicators 120 may include a speaker.

The left shoe indicator 121 may be disposed on and/or within at least a portion of the top surface and/or the bottom surface of the left body 111. Additionally, the right shoe indicator 122 may be disposed on and/or within at least a portion of the top surface and/or the bottom surface of the right body 112. The left shoe indicator 121 may include at least a portion of the picture. Moreover, the right shoe indicator 122 may include at least another portion of the picture. As such, the picture may appear to be complete in response to the left body 111 and the right body 112 being disposed substantially near each other in a first position (i.e. left-right). However, the picture may appear to be incorrect and/or incomplete in response to the left body 111 and the right body 112 being disposed substantially near each other in a second position (i.e. right-left).

The left body 111 may be disposed on and/or inserted into a left shoe 11 and/or a right shoe 12. Similarly, the right body 112 may be disposed on and/or inserted into the right shoe 12 and/or the left shoe 11. As such, the picture may appear complete or incomplete depending on a correct position. Moreover, the left body 111 may fit only the left shoe 11 properly, and the right body 112 may only fit the right shoe 12 properly.

The plurality of sensors 130 may include a weight sensor and/or a movement sensor, but is not limited thereto.

At least one of the plurality of sensors 130 may be disposed within at least a portion of the left body 111. Another at least one of the plurality of sensors 130 may be disposed within at least a portion of the right body 112. The left shoe indicator 121 may emit a sound in response to the at least one of the plurality of sensors 130 detecting a foot being at least partially inserted within the left shoe 11. Similarly, the right shoe indicator 122 may emit another sound in response to the another at least one of the plurality of sensors 130 detecting another foot being at least partially inserted within the right shoe 12. For example, the left shoe indicator 121 may emit “left,” and the right shoe indicator 122 may emit “right.” As such, the left shoe indicator 121 and the right shoe indicator 122 may facilitate correct positioning of the left shoe 11 and the right shoe 12.

The plurality of power sources 140 may include a battery, such as lithium-ion, nickel cadmium, nickel metal hydride, alkaline, etc., but is not limited thereto.

At least one of the plurality of power sources 140 may be disposed within at least a portion of the left body 111. Another at least one of the plurality of power sources 140 may be disposed within at least a portion of the right body 112. The plurality of power sources 140 may provide power to the plurality of shoe indicators 120 and/or the plurality of sensors 130, but is not limited thereto.

Therefore, the footwear insert 100 may facilitate the correct positioning in response to wearing the pair of shoes 10. As such, a user may learn the correct positioning of the pair of shoes 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A footwear insert, comprising:
a plurality of bodies to be disposed within at least a portion of a left shoe and at least a portion of a right shoe; and
a plurality of indicators disposed within at least a portion of the plurality of bodies to indicate a correct position of the plurality of bodies with respect to each other, the plurality of indicators comprising:
a left shoe indicator to emit a sound as left in response to a foot being at least partially inserted within the left shoe, and
a right shoe indicator to emit another sound as right in response to another foot being at least partially inserted within the right shoe.

2. The footwear insert of claim 1, wherein each of the plurality of indicators is at least one of a picture, an image, a letter, and a word.

3. The footwear insert of claim 1, further comprising:
a plurality of sensors disposed on or within at least a portion of the plurality of bodies to detect at least one foot being at least partially inserted within the left shoe or the right shoe.

4. A footwear insert, comprising:
a plurality of rectangular bodies to be disposed within at least a portion of a left shoe and at least a portion of a right shoe, such that each of the plurality of rectangular bodies has a plurality of bubbled protrusions extending away from a top surface of each of the plurality of rectangular bodies;
a plurality of indicators disposed within at least a portion of the plurality of bodies to emit a first sound in response to a first foot being at least partially inserted into the left shoe, and a second sound different from the first sound in response to a second foot being at least partially inserted into the right shoe, such that each of the plurality of indicators have a portion of a star illustrated thereon.
